(19) United States
(12) Patent Application Publication
(10) Pub. No.: US 2018/0105078 A1
(43) Pub. Date: Apr. 19, 2018

(54) MULTI-FUNCTIONAL VEHICLE SEAT

(71) Applicant: Ford Global Technologies, LLC, Dearborn, MI (US)

(72) Inventors: James Nicholas Murray, Chelmsford (GB); James Neugebauer, Chelmsford (GB); Richard Craven, Chelmsford (GB); Sharon Groves, Billericay (GB)

(21) Appl. No.: 15/728,044

(22) Filed: Oct. 9, 2017

(30) Foreign Application Priority Data
Oct. 14, 2016 (GB) 1617452.6

(51) Int. Cl. B60N 2/32; B60N 2/22

(52) U.S. Cl. CPC B60N 2/32; B60N 2/2227

(57) ABSTRACT

A seat for a vehicle is disclosed herein. The seat is configurable in a normal seating position in which a seat base is substantially horizontally arranged and a seatback is arranged in an upright position and a bulkhead configuration in which the seat base and the seatback are both substantially vertically arranged. In the bulkhead configurations, the seat base and the seatback extend upwards from a position close to a floor of the vehicle to a position close to a roof of the vehicle. When in the bulkhead position, the multi-functional seat forms a barrier between a rear cargo space and a front row of seats.

### FIELD OF THE INVENTION

The present disclosure generally relates to a motor vehicle seating assembly, and in particular to a vehicle seating assembly that is configurable into a number of different operational positions.

### BACKGROUND OF THE INVENTION

A seat for a motor vehicle can be configured into a number of different operational positions, including a normal seating position for use as a seat by an occupant of a motor vehicle and a folded position to increase the volume of a luggage or cargo space. A barrier cargo net can be fitted to a motor vehicle to prevent articles stored in a cargo space from impinging against a driver of the vehicle in the event of a sudden deceleration of the vehicle. One example of such a barrier cargo net is disclosed in U.S. Pat. No. 6,817,644.

However, such barrier cargo nets may be problematic because they are time consuming to fit and so are often not used by busy vehicle users. It is also problematic that such barrier cargo nets have to be stored on the vehicle when not in use, thereby taking up valuable storage space. Accordingly, it is desired to provide a seat for a motor vehicle that can be configured to provide a bulkhead between a cargo area and occupants of the vehicle, thereby eliminating the need for the use of a barrier cargo net.

### SUMMARY OF THE INVENTION

According to one aspect of the present disclosure, a vehicle seat is disclosed. The vehicle seat includes a seat base pivotally coupled to a floor of a vehicle. A seatback is pivotally coupled to the seat base. At least one latching mechanism and a drive mechanism are coupled to the seat base and the seatback. The seatback is vertically movable between a normal seating configuration in which the seat base is substantially horizontally arranged and a bulkhead configuration in which the seat base is substantially vertically arranged and the seatback is substantially vertically arranged so as to extend upwards from the seat base to a position close to a roof.

According to another aspect of the present disclosure, a vehicle seat is disclosed. The vehicle seat includes a seatback pivotally coupled to a seat base by a drive mechanism. At least one latching mechanism is coupled with the seatback and includes a latch plate defining first and second recesses. The first recess is configured to couple to a first striker positioned on a floor of the vehicle and the second recess is configured to couple to a second striker positioned on the seat base.

According to yet another aspect of the present disclosure, a vehicle is disclosed. The vehicle includes a passenger compartment defined between a floor and a roof. At least two rows of seats are coupled to the floor. One of the two rows of seats includes at least one multi-functional seat. The at least one multi-functional is seat configured to move between a seating configuration and a bulkhead configuration.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a diagrammatic cut-away left-hand side view of a motor vehicle having a pair of multi-functional seats in a normal seating configuration;

FIG. 2 is a diagrammatic cut-away left-hand side view of the motor vehicle showing the multi-functional seats in a bulkhead configuration;

FIG. 3a is a side view on an enlarged scale of one of the multi-functional seats shown in FIG. 1 showing the multi-functional seat in the normal seating configuration;

FIG. 3b is an enlarged view of a latching mechanism forming part of the multi-functional seat shown in FIG. 3a showing the position of a latch plate when the multi-functional seat is in the normal seating configuration;

FIGS. 4a, 5a, 6a, and 7a are side views of the multi-functional seat shown in FIG. 3a in selected positions as it is transitioned from the normal seating configuration towards the bulkhead configuration;

FIGS. 4b, 5b, 6b, and 7b are enlarged views of the latching mechanism corresponding to FIGS. 4a, 5a, 6a, and 7a as the seat is being transitioned;

FIG. 8a is a side view on an enlarged scale of one of the multi-functional seats shown in FIG. 2 showing the multi-functional seat in the bulkhead configuration; and

FIG. 8b is an enlarged view of the latching mechanism forming part of the multi-functional seat shown in FIG. 8a showing the position of the latch plate when the multi-functional seat is in the bulkhead configuration.

### DETAILED DESCRIPTION OF THE PREFERRED EMBODIMENTS

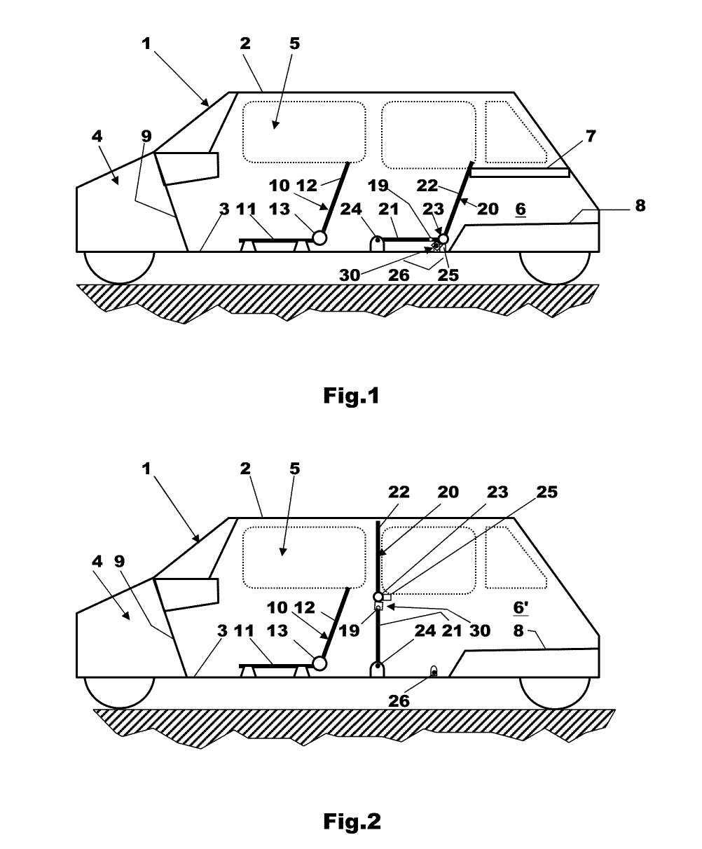

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The presently illustrated embodiments reside primarily in combinations of method steps and apparatus components related to a vehicle seat. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Referring to FIGS. 1-8b, there is provided a multi-functional vehicle seat for mounting in a vehicle including a seat base arranged for pivotal connection at a front end to a floor of the motor vehicle and pivotally connected at a rear end to a seatback to permit relative rotation between the seatback and the seat base, the multi-functional seat being configurable in at least two operational configurations including a normal seating configuration in which the seat base is substantially horizontally arranged and the seatback is arranged in an upright position and a bulkhead configuration in which the seat base is substantially vertically arranged and the seatback is substantially vertically arranged so as to extend upwards from the seat base to a position close to a roof of the vehicle. At least one latching mechanism is provided to retain the multi-functional seat in the normal seating and bulkhead configurations, each latching mechanism includes a latch plate pivotally mounted on the seatback having a first recess for selective co-operation with a first striker attached to the floor of the vehicle in a first latched state to latch the multi-functional seat in the normal seating configuration and a second recess for selective co-operation with a second striker attached to the seat base in a second latched state to latch the multi-functional seat in the bulkhead configuration and a drive mechanism driveably connecting the seat base to the seatback.

A flexible cable may be attached to the latch plate for releasing the latch plate from the first and second latched states. The drive mechanism linking the seat base and the seatback may automatically change the angular relationship between the seat base and the seatback when the multi-functional seat is transitioned in either direction between the normal seating and bulkhead operational configurations. The drive mechanism may include a first drive wheel fastened to the front end of the seat base so as to be coaxially aligned with a pivot axis defined by the pivotal connection of the seat base to the floor of the motor vehicle, a second drive wheel fastened to a lower end of the seatback so as to be coaxially aligned with a pivot axis defined by the pivotal connection between the seat base and the seatback and a flexible drive engaged with the first and second drive wheels so as to provide a driveable connection therebetween. The multi-functional seat may be configurable in three operational configurations comprised of the normal seating configuration, the bulkhead configuration and a stowed configuration in which the seat base is substantially horizontally arranged and the seatback is folded forward so as to lie substantially horizontally upon the seat base

According to a second aspect of the present disclosure, a vehicle has a passenger compartment in which at least two rows of seats are mounted, and one of the two rows of seats includes at least one multi-functional seat mounted in the passenger compartment. The passenger compartment may have a floor and a roof, and each multi-functional seat may extend from a position close to the floor of the passenger compartment to a position close to the roof of the passenger compartment when in the bulkhead configuration. There may be two multi-functional seats mounted in said one row in a side-by-side relationship in the passenger compartment of the motor vehicle. The two rows of seats may include a first row of seats and a second row of seats mounted to the rear of the first row of seats, and the two multi-functional seats form the second row of seats. When both multi-functional seats are in the bulkhead configuration, the second row of seating may form a barrier between the first row of seating and a cargo area to the rear of the second row of seats.

Referring now to FIGS. 1 and 2, there is shown a vehicle 1 having a roof 2, a floor 3, an engine compartment 4, and a passenger compartment 5 separated from the engine compartment by a firewall 9. Two rows of seats are mounted in the passenger compartment 5 there being a first or front row of seats including a pair of seats 10 and a second row of seats including a pair of multi-functional seats 20. It will be appreciated that each of the first and second rows includes a pair of identical seats arranged in a side-by-side relationship of which only the left-hand side seats 10, 20 are shown in FIGS. 1 and 2. Each front row seat 10 has a seat base 11 and a seatback 12 pivotally connected via a pivotal connection 13 that includes a recline mechanism. The front row seats 10 are of a conventional construction. Each second row seat 20 is a multifunctional vehicle seat and has a seat base 21 and a seatback 22 pivotally connected together via a pivotal connection 23 and includes a latching mechanism 30 attached to the seatback 22. The seat base 21 is pivotally connected at a front end to the floor 3 of the vehicle 1 by a pair of hinges 24 and is pivotally connected at a rear end by the pivotal connection 23 to the seatback 22 to permit relative rotation between the seatback 22 and the seat base 21. The seatback 22 includes, at one end, a pair of rear supports 25 that rest upon the floor 3 when the multi-functional seat 20 is in a normal seating configuration as shown in FIG. 1. The latching mechanism 30 is engageable with a floor-mounted striker 26 when the multi-functional seat 20 is in the normal seating configuration and is engageable with a seat striker 19 fastened to the seat base 21 when the multi-functional seat 20 is in a bulkhead configuration shown in FIG. 2. When the second row multi-functional seats 20 are in the normal seating configuration, a cargo area or luggage compartment 6 is formed to the rear of the second row of multi-functional seats 20.

A parcel shelf 7 is provided to obscure from view articles carried in the cargo area 6. In the case of the embodiment shown in FIGS. 1 and 2, the floor 3 of the motor vehicle 1 has a raised rear portion 8 which forms a floor of the cargo area 6. When the second row multi-functional seats 20 are in the bulkhead configuration, a larger cargo area or luggage compartment 6′ is formed to the rear of the second row of multi-functional seats 20 and each multi-functional seat 20 extends from a position close to the floor 3 of the passenger compartment 5 to a position close to the roof 2 of the passenger compartment 5.

As shown in FIG. 1, in the normal seating configuration the seat base 21 of each of the multi-functional seats 20 is substantially horizontally arranged and the seatback 22 of each of the multi-functional seats is arranged in an upright position. That is to say, the seatback 22 extends upwardly from the pivotal connection 23 to the seat base 21 and is arranged at an internal angle in a range of 90 to 120 degrees with respect to the seat base 21.

As shown in FIG. 2, in the bulkhead configuration the seat base 21 of each of the multi-functional seats 20 is substantially vertically arranged and the seatback 22 is substantially vertically arranged so as to extend upwards from the seat base 21 to a position close to the roof 2 of the motor vehicle 1. The seat base 21 and the seatback 22 are substantially vertically aligned and lie on a common plane when in the bulkhead configuration in the case of this embodiment. To transition each of the second row seats 20 from their normal seating configuration to the bulkhead configuration, the latching mechanism 30 is released from its respective floor-mounted striker 26 allowing a rear end of the seat base 21 to be lifted using the seatback 22 thereby causing the seat base 21 to rotate about the pivotal connection at the front end of the seat base 21 formed by the pair of hinges 24. The seatback 22 is lifted until the seat base 21 and the seatback 22 are nearly aligned vertically at which point the latching mechanism 30 engages with the seat striker 19 fastened to the seat base 21. The engagement of the latching mechanism 30 with the seat striker 19 holds the multi-functional seat 20 in the bulkhead configuration such that the seat base 21 and the seatback 22 are substantially vertically aligned.

It will be appreciated that to transition the multi-functional seat 20 from the bulkhead configuration to the normal seating configuration the opposite procedure is followed. That is to say, the latching mechanism 30 is released from the seat striker 19 and the seatback 22 is lowered until the latching mechanism 30 on the seatback 22 latches with the floor-mounted striker 26. It will be further appreciated that the height of the passenger compartment 5 of the motor vehicle 1 between the roof 2 and the floor 3 is slightly greater than the combined lengths of the seat base 21 and the seatback 22 so that when both of the multi-functional seats 20 are in their respective bulkhead configurations, the second row of seats 20 forms a barrier between the first row of seats 10 and the cargo area 6′ to the rear of the second row of seats 20 that extends from a position close to the roof 2 to a position close to the floor 3. Therefore, a multi-functional seat in accordance with this disclosure when in the bulkhead configuration permits articles to be safely transported without the need for the fitment of a barrier cargo net.

Although the multi-functional seat has been described with reference to an embodiment in which the multi-functional seats form a second row of seats, it will be appreciated that the seat is not limited to such use, and the multi-functional seats could for example form a third row of seats in which case the third row of seats would, when in the bulkhead configuration, form a barrier between a cargo area to the rear of the third row of seats and the part of the passenger compartment in front of the third row of seats. Although the seat is shown in FIGS. 1 and 2 within a hatchback-type vehicle, it will be appreciated that it could be applied with equal merit to any type of vehicle, such as, for example, a MPV, SUV, or crew-cab-type vehicle having two or more rows of seats.

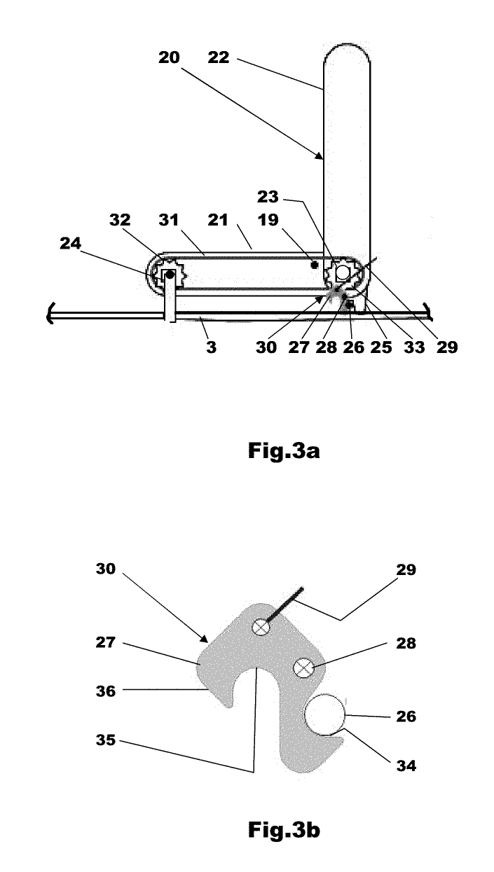

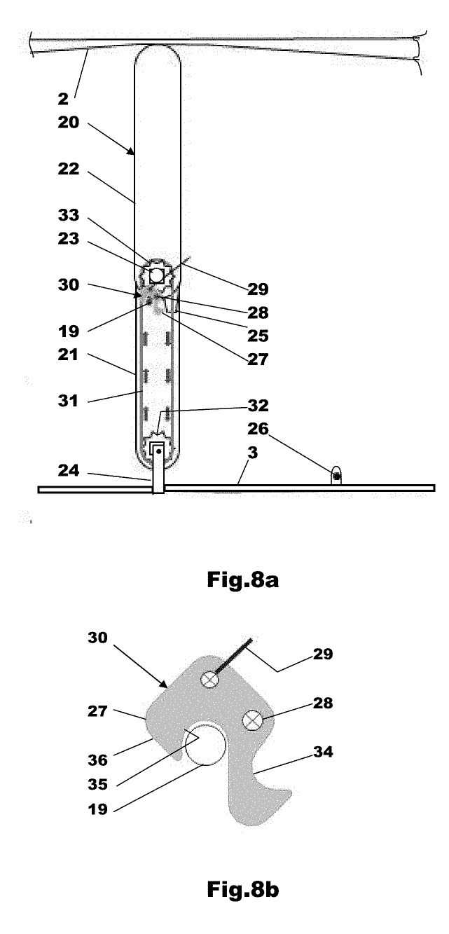

Referring now to FIGS. 3a-8b, the multi-functional seat 20 is shown in greater detail in various stages of transition from the normal seating configuration shown in FIGS. 1 and 3a to the bulkhead configuration shown in FIGS. 2 and 8a. The latching mechanism 30 includes a latch plate 27 pivotally mounted on the seatback 22 having a first recess 34 for selective co-operation with the floor-mounted striker 26 in a first latched state so as to latch the multi-functional seat 20 in the normal seating configuration and a second recess 35 for selective co-operation with the seat striker 19 attached to the seat base 21 in a second latched state so as to latch the multi-functional seat 20 in the bulkhead configuration.

Referring still to FIGS. 3a-8b, the latching mechanism 30 further includes a pivot pin 28 used to pivotally attach the latch plate 27 to a structural part of the seatback 22 and a flexible cable 29 attached to the latch plate 27 for releasing the latch plate 27 from the first and second latched states. A torsion spring (not shown) is engaged with the pivot pin 28 and arranged to react between the latch plate 27 and a structural part of the seatback 22 so as to bias the latch plate 27 in a striker engaging direction which in the case of this example is an anti-clockwise direction about the pivot pin 28. The flexible cable 29 has a user grip at a remote end (not shown) by which a user of the vehicle 1 can selectively release the latch plate 27 from the first and second latched states by pulling on the flexible cable 29, which will cause the latch plate 27 to be rotated in a clockwise direction about the pivot pin 28 against the action of the torsion spring.

Still referring to FIGS. 3a-8b, in addition to the latching mechanism 30, the multi-functional seat 20 also includes a drive mechanism linking the seat base 21 and the seatback 22 to automatically change the angular relationship between the seat base 21 and the seatback 22 when the multi-functional seat 20 is transitioned in either direction between the normal seating and bulkhead operational configurations and assist with the holding of the multi-functional seat 20 in the bulkhead configuration as is described in more detail hereinafter. The drive mechanism includes a first drive wheel in the form of a toothed pulley 32 fastened to the front end of the seat base 21. The toothed pulley 32 is coaxially aligned with a pivot axis defined by the pivotal connection formed by the pair of hinges 24 between the seat base 21 and the floor 3 of the vehicle 1, while a second drive wheel in the form of a toothed pulley 33 is fastened to a lower end of the seatback 22 so as to be coaxially aligned with the pivot axis defined by the pivotal connection 23 between the seat base 21 and the seatback 22 and a flexible drive in the form of a toothed belt 31 engaged with the first and second toothed pulleys 32 and 33 so as to provide a driveable connection therebetween. Although the drive mechanism in the case of this example includes of a pair of toothed pulleys 32, 33 and a continuous toothed drive belt 31, it will be appreciated that it is not limited to such an arrangement and could, for example, include a pair of sprockets and a chain drive or a pair of pulleys and a flat or Vee drive belt or any other suitable drive mechanism.

Referring to FIGS. 3a and 3b, the multi-functional seat 20 is shown in the normal seating configuration with the floor-mounted striker 26 held captive by the first recess 34 in the latch plate 27. In this state, the multi-functional seat 20 is latched to the floor 3 of the motor vehicle 1.

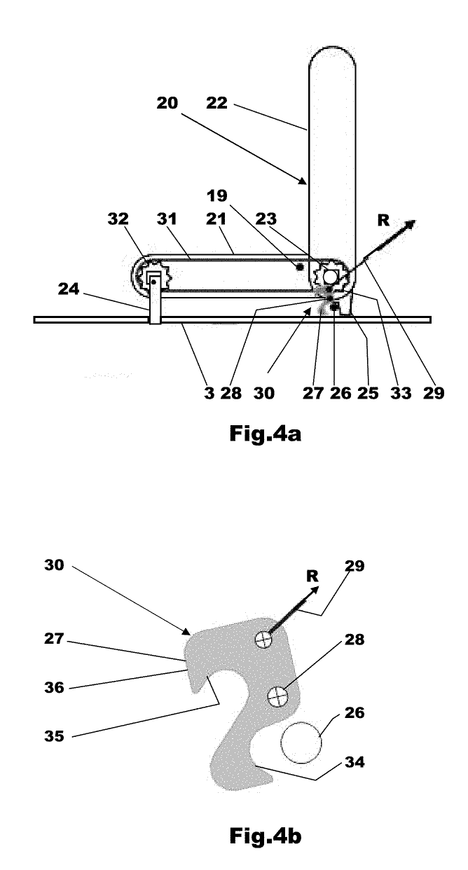

Referring to FIGS. 4a and 4b, the multi-functional seat 20 is shown in a first stage of transition from the normal seating position towards the bulkhead configuration. The seat base 21 has not moved, but the latch plate 27 has been rotated by the application of a force “R” to the flexible cable 29 as indicated by the arrow “R” on FIGS. 4a and 4b. The floor-mounted striker 26 is no longer held captive by the first recess 34 in the latch plate 27 and in this state the multi-functional seat 20 is no longer latched to the floor 3 of the motor vehicle 1.

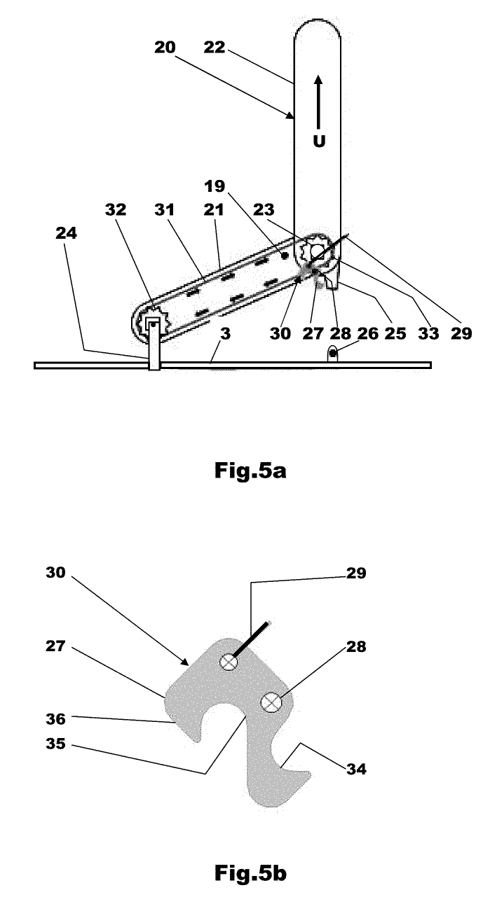

As shown in FIGS. 5a and 5b, the multi-functional seat 20 is in a second stage of transition from the normal seating position towards the bulkhead configuration. The seat base 21 has been rotated approximately 25 degrees about the pivotal axis defined by the pair of hinges 24 from the normal seating configuration by the application of an upward force indicated by the arrow “U” in FIG. 5a and the latch plate 27 has been consequently moved clear of the floor-mounted striker 26. There is no longer a need for the flexible cable 29 to be pulled by a user of the motor vehicle 1 as there is no contact between the latch plate 27 and either of the strikers 19, 26.

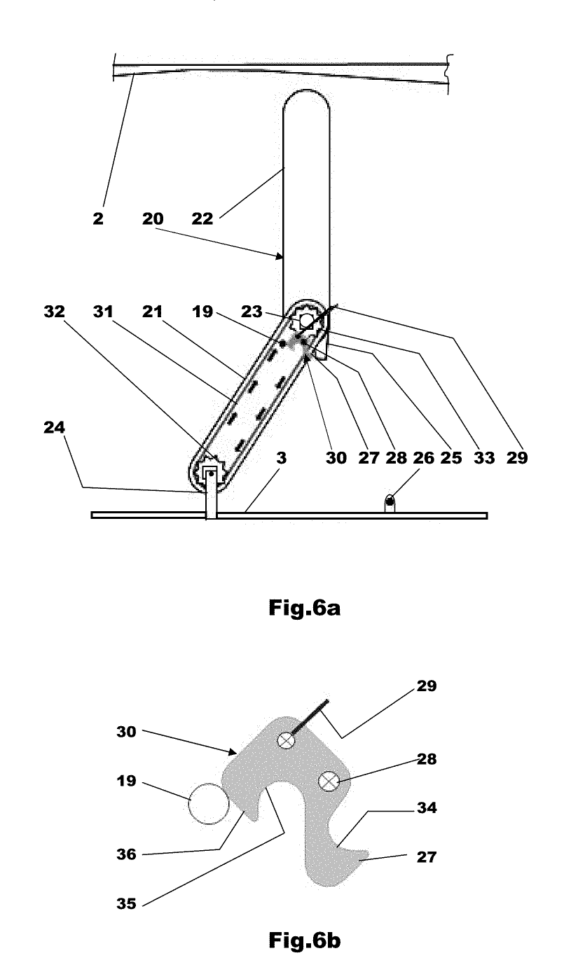

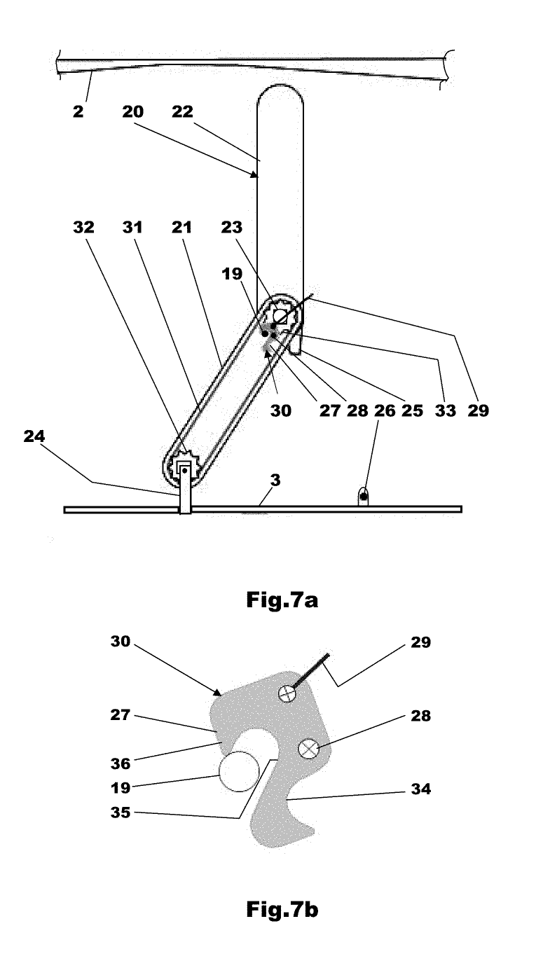

Referring FIGS. 6a and 6b, the multi-functional seat 20 is in a third stage of transition from the normal seating position towards the bulkhead configuration. The seat base 21 has been rotated approximately 60 degrees about the pivotal axis defined by the pair of hinges 24 from the normal seating configuration by the application of an upward force, and an abutment surface 36 on the latch plate 27 has made contact with the seat striker 19. There is no need for the flexible cable 29 to be pulled by a user of the motor vehicle 1 because the contact between the abutment surface 36 on the latch plate 27 and the seat striker 19 will cause the latch plate 27 to be rotated in a clockwise direction as the seatback 22 continues to be moved upwardly until, as shown in FIGS. 7a and 7b, the latch plate 27 has been rotated sufficiently to enable the seat striker 19 to engage with the second recess 35 in the latch plate 27, constituting a fourth stage of transition. Further upward movement of the seatback 22 will cause the seat striker 19 to fully enter with clearance the second recess 35, and the torsion spring then acts to rotate the latch plate 27 in an anti-clockwise direction so as to trap the seat striker 19 in the second recess 35 thereby latching the seat base 21 and the seatback 22 together in the bulkhead configuration as shown in FIGS. 8a and 8b. It will be appreciated that, because the seat base 21 and the seatback 22 are driveably interconnected by the drive mechanism 31, 32, 33, the seat base 21 cannot rotate relative to the floor 3, as to do so would require relative movement between the seat base 21 and the seatback 22, which is prevented by the engagement of the latch plate 27 of the latching mechanism 30 with the seat striker 19. Therefore, the drive mechanism 31, 32, 33 is advantageous in that it provides two functions: firstly, to control the relative orientation of the seat base 21 and the seatback 22 during transition and, secondly, to hold the multi-functional seat 20 in the bulkhead configuration without requiring the use of an additional latching mechanism.

Referring to FIGS. 8a and 8b, to transition the multi-functional seat 20 from the bulkhead configuration shown in FIG. 8a back to the normal seating configuration requires the latch plate 27 to be released from the seat striker 19 by a user of the motor vehicle 1 pulling and then releasing the flexible cable 29 after the seat striker 19 has moved out of the second recess 35 followed by a lowering of the seatback 22 until the first recess 34 in the latch plate 27 engages with the floor-mounted striker 26. It will be appreciated that each multi-functional seat 20 could have a pair of latching mechanisms and a pair of drive mechanisms 31, 32, 33 associated with it, one on each side of the respective seat 20. It will also be appreciated that the flexible cable need not be a manually operated cable but could be a release lever or cable actuated by an electrical actuator in response to a user pressing a button or operating another form of Human Machine Interface. It will be further appreciated that instead of having a pair of multi-functional seats, the second row of seats could be formed by a single bench-type seat constructed in a similar manner to the multi-functional seat 20 and usable in the same manner to provide a temporary bulkhead separating a passenger area and a cargo area of the motor vehicle 1. In some instances, an underside of the seat base that faces down in the normal seating configuration and a rear face of the seatback that faces towards the rear of the motor vehicle in the normal seating configuration are both constructed so as to have a rigid resilient covering to resist damage from cargo impacts when the multi-functional seat is in the bulkhead configuration.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle seat comprising:
a seat base pivotally coupled to a floor of a vehicle;
a seatback pivotally coupled to the seat base;
at least one latching mechanism; and
a drive mechanism coupled to the seat base and the seatback, wherein the seatback is vertically movable between a normal seating configuration in which the seat base is substantially horizontally arranged and a bulkhead configuration in which the seat base is substantially vertically arranged and the seatback is substantially vertically arranged so as to extend upwards from the seat base to a position close to a roof.

2. The multi-functional vehicle seat of claim 1, wherein the seat base and the seatback are further movable to a stowed configuration.

3. The vehicle seat of claim 2, wherein the seat base and the seatback are vertically aligned in the bulkhead configuration.

4. The vehicle seat of claim 1, wherein the seatback is disposed above the seat base in the bulkhead configuration.

5. The vehicle seat of claim 1, wherein the latching mechanism further comprises:
a latch plate;
a first recess defined by the latch plate, wherein the first recess is configured to hold the multi-functional vehicle seat in the normal seating configuration; and
a second recess defined by the latch plate, wherein the second recess is configured to hold the multi-functional vehicle seat in the bulkhead configuration.

6. The vehicle seat of claim 5, wherein the first recess is configured to operably couple with a first striker, and wherein the first striker is disposed on a floor of the vehicle.

7. The vehicle seat of claim 5, wherein the second recess is configured to operably couple with a second striker, and wherein the second striker is disposed on the seat base.

8. The vehicle seat of claim 5, wherein a flexible cable is attached to the latch plate for releasing the latch plate from the first and second latched states.

9. The vehicle seat of claim 1, wherein the drive mechanism coupling the seat base and the seatback changes the angular relationship between the seat base and the seatback when the seatback is transitioned between the normal seating configuration and the bulkhead configuration.

10. The vehicle seat of claim 1, wherein the drive mechanism further comprises:
a first drive wheel coupled to a front end of the seat base, wherein the first drive wheel is coaxially aligned with a pivot axis;
a second drive wheel coupled to a lower end of the seatback, wherein the second drive wheel is coaxially aligned with the pivot axis; and
a flexible drive operably coupled with the first and second drive wheels so providing a driveable connection therebetween.

11. The vehicle seat of claim 10, wherein the pivot axis is defined by the pivotal connection of the seat base to the floor of a vehicle.

12. A vehicle seat comprising:
a seatback pivotally coupled to a seat base by a drive mechanism; and
at least one latching mechanism coupled with the seatback and including a latch plate defining first and second recesses, wherein the first recess is configured to couple to a first striker positioned on a floor of the vehicle and the second recess is configured to couple to a second striker positioned on the seat base.

13. The vehicle seat of claim 12, wherein the seatback and seat base are configured to move between a seating configuration and a bulkhead configuration.

14. The vehicle seat of claim 13, wherein the seatback and seat base are further configured to move to a stowed configuration.

15. The vehicle seat of claim 13, wherein the seatback is disposed above the seat base in the bulkhead configuration.

16. A vehicle comprising:
a passenger compartment defined between a floor and a roof; and
at least two rows of seats coupled to the floor, wherein one of the two rows of seats includes at least one multi-functional seat, the at least one multi-functional seat configured to move between a seating configuration and a bulkhead configuration.

17. The vehicle of claim 16, wherein the at least one multi-functional seat further comprises:
a seat base, wherein the seat base is configured to pivotally couple to a floor of the vehicle; and
a seatback, wherein the seatback is pivotally coupled to the seat base.

18. The vehicle of claim 17, wherein the seatback extends from a position close to the floor of the passenger compartment in the seating configuration to a position close to the roof of the passenger compartment when in the bulkhead configuration.

19. The vehicle of claim 17, further comprising:
a latching mechanism; and
a drive mechanism connecting the seat base to the seatback.

20. The vehicle of claim 16, wherein, when the multi-functional seat is in the bulkhead configuration, the multi-functional seat forms a barrier between the first row of seats and a cargo area to the rear of the multi-functional seat.
